(19) United States
(12) Patent Application Publication
(10) Pub. No.: US 2025/0334215 A1
(43) Pub. Date: Oct. 30, 2025

(54) STAINLESS STEEL COUPLING ASSEMBLY FOR CONNECTING PIPES

(71) Applicant: NEW ASIA Co., Ltd., Yeoju-si, Gyeonggi-do (KR)

(72) Inventor: Sang Heon Lee, Seoul (KR)

(21) Appl. No.: 18/557,246

(22) PCT Filed: Aug. 9, 2023
(86) PCT No.: PCT/KR2023/011760

§ 371 Date: Dec. 31, 2024

(30) Foreign Application Priority Data
Aug. 25, 2022 (KR) 10-2022-0106598
Nov. 18, 2022 (KR) 10-2022-0155119

(51) Int. Cl. F16L 23/08; F16L 23/18

(52) U.S. Cl. CPC F16L 23/08; F16L 23/18

(57) ABSTRACT

Provided is a stainless steel coupling assembly for connecting pipes, in which two or more stainless steel couplers are placed opposite to connect the pipes continuously placed along the axial direction, and the pipes are connected in such a way that the plurality of couplers are disposed around the pipes and are fastened to each other. The coupler includes a body part provided with an internal space where a sealing member is disposed; a locking part that extends inward in the radial direction at both ends of the body part in the width direction and is inserted into a fastening groove formed in the pipe; and a fastening part disposed at both ends in the circumferential direction of the body part and through which a fastening member is fastened. On the top surface of the body part, a first rib protruding outward in the radial direction is formed.

### TECHNICAL FIELD

The present invention relates to a coupling assembly for connecting pipes, and more particularly, to a stainless steel coupling assembly for connecting pipes.

### BACKGROUND

Generally, in order to connect pipes arranged continuously along the axial direction, pipes are connected using a coupling assembly. This coupling assembly includes a plurality of interconnectable couplers disposed along the circumferential direction of the pipe, and connects continuous pipes by fastening the plurality of couplers to each other using separate fastening members while placing these couplers at the end of the pipe.

Meanwhile, in the semiconductor and LCD manufacturing process, general gases consumed in relatively large quantities such as dry air, nitrogen, oxygen, hydrogen, argon, and helium, and special material gases such as monosilane, phosphine, nitrogen trifluoride, and ammonia, are supplied through gas supply facilities, and these gas supply facilities consist of special piping facilities with sufficient cleanliness, corrosion resistance, and strength to prevent contamination or leakage while maintaining the high purity of general gas and special material gas. These special piping facilities are selected considering quality, stability, ease of maintenance, and economic efficiency, and stainless steel pipes, which have excellent corrosion resistance, are usually used.

In addition, it is desirable to use a coupling assembly made of stainless steel to ensure sufficient cleanliness, corrosion resistance, and strength for connecting these stainless steel pipes, and when the coupling assembly is made of stainless steel, there is a problem that leakage occurs as the coupling assembly separates from the stainless steel pipe during use due to the mechanical properties such as ductility of the stainless steel material.

In addition, a coupling assembly made of stainless steel can be used to connect the pipe through which water flows inside, but even in this case, there is a problem of water leakage occurring as the coupling assembly is separated from the pipe due to the pressure of water flowing inside the pipe.

Therefore, even if the coupling assembly is made of stainless steel, there is a need to develop a coupling assembly having a stable structure that does not separate from the stainless steel pipe during use.
(Patent Document 1) Korean Patent Laid-Open Publication No. 10-2007-0012723 (published 2007 Jan. 26.)

### SUMMARY OF THE INVENTION

### Technical Tasks

The present invention is to solve the above problems, and the present invention is directed to providing a stainless steel coupling assembly for connecting pipes having a stable structure that does not separate from the stainless steel pipe during use even if the coupler provided in the coupling assembly is made of stainless steel.

The problems of the present invention are not limited to those mentioned above, and other problems not mentioned will be clearly understood by those of ordinary skill in the art from the following description.

### Technical Solution

According to an aspect of the present invention, provided is a stainless steel coupling assembly for connecting pipes according to an aspect of the present invention, in which two or more stainless steel couplers are placed opposite to connect the pipes continuously placed along the axial direction, and the pipes are connected in such a way that the plurality of couplers are disposed around the pipes and are fastened to each other, wherein the coupler includes a body part provided with an internal space where a sealing member is disposed; a locking part that extends inward in the radial direction at both ends of the body part in the width direction and is inserted into a fastening groove formed in the pipe; and a fastening part disposed at both ends in the circumferential direction of the body part and through which a fastening member is fastened, and wherein on the top surface of the body part, a first rib protruding outward in the radial direction is formed extending along the circumferential direction.

In this case, at least one first rib may be provided along the width direction.

In this case, on the top surface of the body part, a second rib protruding outward in the radial direction may be formed extending along the width direction.

In this case, at least one second rib may be provided along the circumferential direction.

In this case, on a side surface of the body part, a third rib protruding along the width direction may be formed extending along the radial direction.

In this case, at least one third rib may be provided along the circumferential direction.

In this case, the extension length of the third rib in the circumferential direction may increase as it goes inward in the radial direction.

In this case, the third rib may be provided with an inclined surface arranged to form a constant rib inclination angle based on a center line disposed along the radial direction.

In this case, the third rib may be provided with a pair of inclined surfaces arranged opposite to each other along the circumferential direction, and the rib inclination angle of the pair of inclined surfaces may be formed to be equal to each other.

In this case, the third rib may be provided with a pair of inclined surfaces arranged opposite to each other along the circumferential direction, and the rib inclination angles of the pair of inclined surfaces may be formed to be different from each other.

In this case, among the pair of inclined surfaces, the rib inclination angle of one inclined surface disposed adjacent to the fastening part may be formed to be greater than the rib inclination angle of the other inclined surface.

In this case, the body part may be provided with a fourth rib connecting a side surface of the body part and the fastening part.

In this case, the fastening member may include a head having a polygonal cross-section, and a body extending from the head, and the fastening part may be provided with a support surface that prevents the head from rotating.

In this case, the fastening part may be provided with an insertion groove into which the head is inserted, and the support surface may be disposed on the inner surface of the insertion groove.

In this case, the fastening member may further include a nut fastened to the body with the body disposed through the fastening part, and a support plate having an outer diameter greater than the outer diameter of the insertion groove to prevent the nut from being inserted into the insertion groove.

In this case, the nut and the support plate may be formed integrally.

In this case, the protruding length in the radial direction of the locking part may be formed to be greater than the depth of the fastening groove.

In this case, the bottom surface of the body part may be provided with a separation surface spaced apart from the outer surface of the pipe.

In this case, a first body inclination angle may be formed on the separation surface so that a separation distance between the separation surface and the outer surface of the pipe increases along the width direction.

In this case, a second body inclination angle may be formed on the separation surface so that a separation distance between the separation surface and the outer surface of the pipe decreases along the width direction.

### Advantageous Effects

According to the above configuration, in the stainless steel coupling assembly for connecting pipes according to an embodiment of the present invention, since the first rib protruding outward in the radial direction is formed on the top surface of the body part and extends along the circumferential direction, even if high-pressure fluid, such as gas or water, flows inside the pipe while the coupling assembly is fastened to the pipe, the first rib prevents deformation of the coupler, so that the locking part does not separate from the fastening groove, and through this, it is possible to effectively prevent water leakage from occurring in the pipe.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view showing a state in which a pipe is fastened to a stainless steel coupling assembly for connecting pipes according to an embodiment of the present invention.

FIG. 2 is a perspective view showing a disassembled state of a stainless steel coupling assembly for connecting pipes and a pipe according to an embodiment of the present invention.

FIG. 3 is a perspective view of a coupler according to an embodiment of the present invention.

FIG. 4 is a front view of a coupler according to an embodiment of the present invention.

FIG. 5 is a side view of a coupler according to an embodiment of the present invention.

FIG. 6 is a plan view of a coupler according to an embodiment of the present invention.

FIG. 7 is a bottom view of a coupler according to an embodiment of the present invention.

FIG. 8 is a plan view of a coupler according to another embodiment of the present invention.

FIG. 9 is an enlarged view of portion A of FIG. 4.

FIG. 10 is an enlarged view of portion B of FIG. 4.

FIG. 11 is a simulation result of the overall stress distribution formed in the coupler when the coupling assembly is fastened, where (a) of FIG. 11 is the result for the conventional coupler, and (b) of FIG. 11 is the result for the coupler according to the present invention.

FIG. 12 is a simulation result of a stress distribution greater than or equal to the yield strength formed in the coupler when the coupling assembly is fastened, where (a) of FIG. 12 is the result for the conventional coupler, and (b) of FIG. 12 is the result for the coupler according to the present invention.

FIG. 13 is a simulation result of the total displacement according to the deformation of the coupler when the coupling assembly is fastened, where (a) of FIG. 13 is the result for the conventional coupler, and (b) of FIG. 13 is the result for the coupler according to the present invention.

FIG. 14 is a cross-sectional view in the radial direction of a stainless steel coupling assembly for connecting pipes according to an embodiment of the present invention.

FIG. 15 is an enlarged view of portion C of FIG. 14.

FIG. 16 is an enlarged view of portion D of FIG. 14.

FIG. 17 is a view showing a nut according to another embodiment of the present invention, where (a) of FIG. 17 is a front view and (b) of FIG. 17 is a plan view.

FIG. 18 is a view showing a nut according to yet another embodiment of the present invention, where (a) of FIG. 18 is a front view and (b) of FIG. 18 is a plan view.

FIG. 19 is a cross-sectional view in the width direction of a stainless steel coupling assembly for connecting pipes and a pipe according to an embodiment of the present invention.

FIG. 20 is a cross-sectional view in the width direction of a stainless steel coupling assembly for connecting pipes and a pipe according to another embodiment of the present invention.

FIG. 21 is a cross-sectional view in the width direction of a stainless steel coupling assembly for connecting pipes and a pipe according to yet another embodiment of the present invention.

### DETAILED DESCRIPTION OF EMBODIMENTS

Hereinafter, embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition, and they should be interpreted as a meaning and concept consistent with the technical idea of the present invention based on the principle that inventors may appropriately define the terms and concept in order to describe their own invention in the best way.

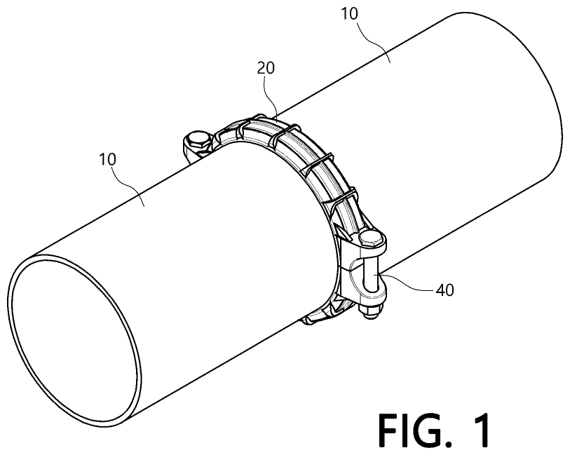

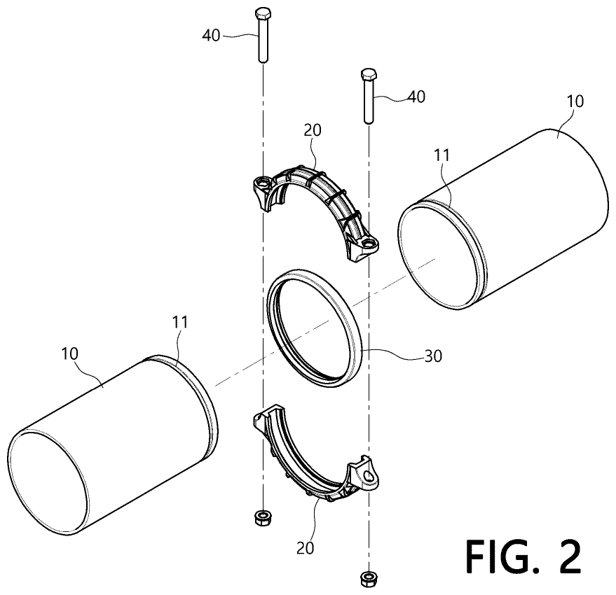

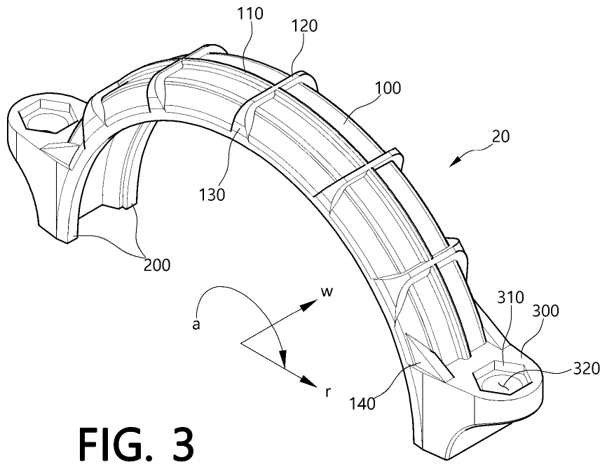

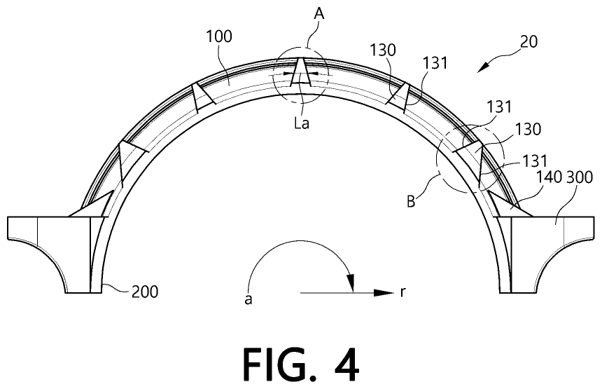

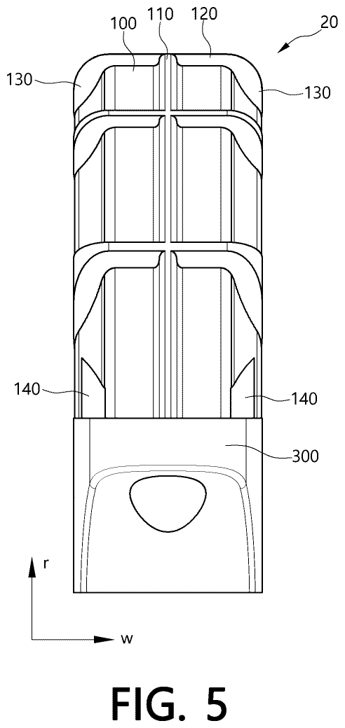

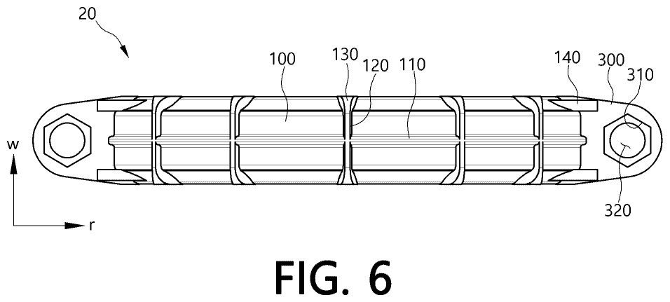

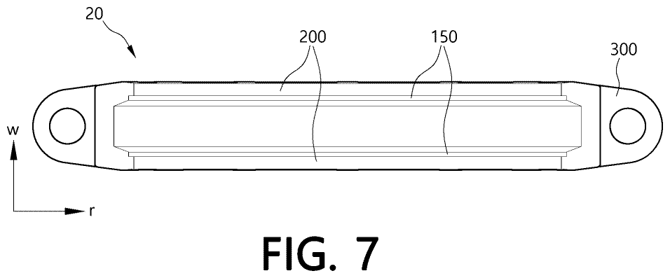

FIG. 1 is a perspective view showing a state in which a pipe is fastened to a stainless steel coupling assembly for connecting pipes according to an embodiment of the present invention; FIG. 2 is a perspective view showing a disassembled state of a stainless steel coupling assembly for connecting pipes and a pipe according to an embodiment of the present invention; FIG. 3 is a perspective view of a coupler according to an embodiment of the present invention; FIG. 4 is a front view of a coupler according to an embodiment of the present invention; FIG. 5 is a side view of a coupler according to an embodiment of the present invention; FIG. 6 is a plan view of a coupler according to an embodiment of the present invention; and FIG. 7 is a bottom view of a coupler according to an embodiment of the present invention. Here, the w direction means the width direction, the r direction means the radial direction, and the a direction means the circumferential direction. For clarity of description of the present invention, parts not related to the description are omitted in the drawings.

As shown in FIGS. 1 and 2, according to an embodiment of the present invention, a stainless steel coupling assembly is provided in which two or more stainless steel couplers 20 are placed opposite to connect pipes 10 continuously placed along the axial direction, and the pipes 10 are connected in such a way that the plurality of couplers 20 are disposed around the pipes 10 and are fastened to each other.

In this case, as shown in FIGS. 3 to 7, the coupler 20 includes a body part 100 provided with an internal space where a sealing member 30 is disposed, a locking part 200 that extends inward in the radial direction (r) at both ends of the body part 100 in the width direction (w) and is inserted into a fastening groove 11 formed in the pipe 10, and a fastening part 300 disposed at both ends in the circumferential direction (a) of the body part 100 and through which a fastening member 40 is fastened, and on the top surface of the body part 100, a first rib 110 protruding outward in the radial direction (r) is formed extending along the circumferential direction (a).

In this case, the first rib 110 may be formed continuously along the circumferential direction (a), but is not necessarily limited thereto, and it is also possible to configure a plurality of first ribs 110 arranged on the same line along the circumferential direction (a) at regular intervals.

That is, since the first rib 110 protruding outward in the radial direction (r) is formed on the top surface of the body part 100 and extends along the circumferential direction (a), even if high-pressure fluid, such as gas or water, flows inside the pipe 10 while the coupling assembly is fastened to the pipe 10, the first rib 110 prevents deformation of the coupler 20, so that the locking part 200 does not separate from the fastening groove 11, and through this, it is possible to effectively prevent water leakage from occurring in the pipe 10.

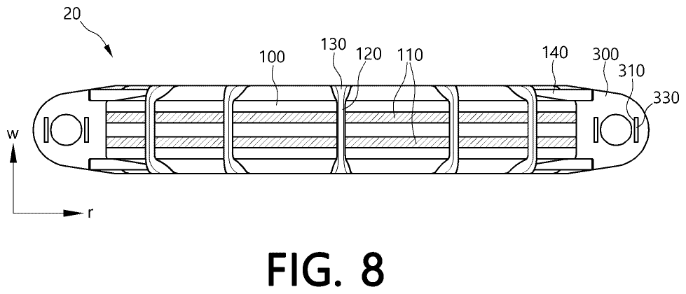

FIG. 8 is a plan view of a coupler according to another embodiment of the present invention.

As shown in FIG. 8, at least one first rib 110 may be provided along the width direction (w). That is, the plurality of first ribs 110 formed extending along the circumferential direction (a) are configured to be spaced apart along the width direction (w). In this case, as described above, it is also possible to configure a plurality of first ribs 110 arranged on the same line along the circumferential direction (a) at regular intervals. Through this, deformation of the coupler 20 can be more effectively prevented, preventing the locking part 200 from separating from the fastening groove 11 and effectively preventing water leakage from occurring in the pipe 10.

As shown in FIG. 6, on the top surface of the body part 100, a second rib 120 protruding outward in the radial direction (r) may be formed extending along the width direction (w). This second rib 120 can more effectively prevent the coupler 20 from being deformed along the width direction (w).

In this case, as shown in FIG. 6, at least one second rib 120 may be provided along the circumferential direction (a), and through which the coupler 20 can be more effectively prevented from being deformed along the width direction (w).

As shown in FIG. 4, on a side surface of the body part 100, a third rib 130 protruding along the width direction (w) may be formed extending along the radial direction (r). That is, the above-described first rib 110 and second rib 120 are formed on the top surface of the body part 100 to prevent deformation of the coupler 20, and the third rib 130 is formed on a side surface of the body part 100 to prevent deformation of the coupler 20. Since the third rib 130 is formed extending along the radial direction (r), it can effectively prevent deformation in the width direction (w) and the radial direction (r) even when the pressure of high-pressure fluid is applied to the pipe 10.

In this case, as shown in FIG. 4, at least one third rib 130 may be provided along the circumferential direction (a), and through which the coupler 20 can be more effectively prevented from being deformed in the width direction (w) and the radial direction (r).

As shown in FIG. 4, the extension length (La) of the third rib 130 in the circumferential direction (a) may increase as it goes inward in the radial direction (r). As described above, when the pressure of high-pressure fluid is applied to the pipe 10, the locking part 200 may separate from the fastening groove 11 and leakage may occur, so it is necessary to prevent deformation of the locking part 200.

Therefore, the third rib 130 is provided on the side surface of the body part 100, and the extension length (La) in the circumferential direction (a) increases as the third rib 130 goes inward in the radial direction (r), making it possible to intensively prevent deformation of the locking part 200.

As shown in FIG. 4, the third rib 130 may be provided with an inclined surface 131 arranged to form a constant rib inclination angle Θ based on the center line (c) disposed along the radial direction (r). That is, as the third rib 130 is provided with the inclined surface 131, the extension length (La) in the circumferential direction (a) increases as the third rib 130 goes inward in the radial direction (r), which makes it possible to intensively prevent deformation of the locking part 200.

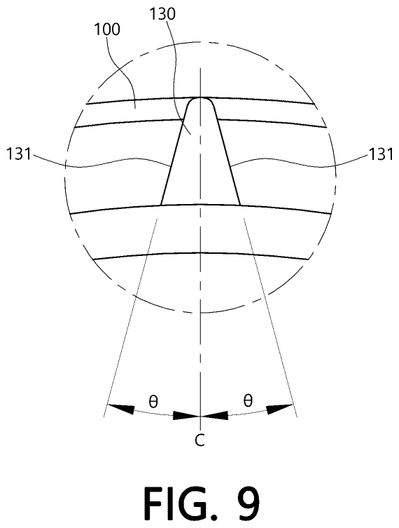

FIG. 9 is an enlarged view of portion A of FIG. 4.

As shown in FIG. 9, the third rib 130 is provided with a pair of inclined surfaces 131 arranged opposite to each other along the circumferential direction (a), and the rib inclination angle Θ of the pair of inclined surfaces 131 may be formed to be equal to each other. That is, when the stress is formed uniformly along the circumferential direction (a) considering the overall stress distribution formed in the coupler 20 when the coupling assembly is fastened, if the rib inclination angle Θ of the pair of inclined surfaces 131 is formed to be the same, it is possible to effectively prevent deformation of the locking part 200 along the circumferential direction (a).

As an example, the rib inclination angle Θ formed on this pair of inclined surfaces 131 may be formed to be the same as 15°, but is not necessarily limited to 15°, and It is also possible to configure it differently depending on the diameter of the pipe 10 to which the coupling assembly is fastened.

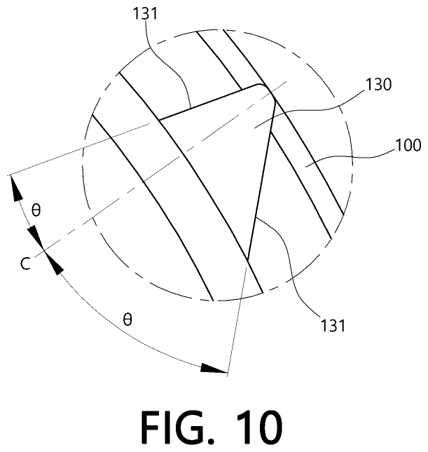

FIG. 10 is an enlarged view of portion B of FIG. 4.

As shown in FIG. 10, the third rib 130 is provided with a pair of inclined surfaces 131 arranged opposite to each other along the circumferential direction (a), and the rib inclination angles Θ of the pair of inclined surfaces 131 may be formed to be different from each other. That is, when the stress is not formed uniformly along the circumferential direction (a) considering the overall stress distribution formed in the coupler 20 when the coupling assembly is fastened, and the stress is concentrated on one side, by forming the rib inclination angles Θ of the pair of inclined surfaces 131 to be different from each other, it is possible to effectively prevent deformation of the portion where stress is concentrated and the portion where stress is not concentrated.

As shown in FIGS. 9 and 10, among the pair of inclined surfaces 131, the rib inclination angle Θ of one inclined surface 131 disposed adjacent to the fastening part 300 may be formed to be greater than the rib inclination angle Θ of the other inclined surface 131. That is, when the coupling assembly is fastened using the fastening member 40, the fastening force of the fastening member 40 is applied to the fastening part 300, and stress is concentrated in a portion adjacent to the fastening part 300.

In this case, as shown in FIG. 4, the third rib 130 located on the uppermost side may have the same rib inclination angle Θ of the pair of inclined surfaces 131, and the third rib 130 located on the lowermost side may have a rib inclination angle Θ of the inclined surface 131 adjacent to the fastening part 300 among the pair of inclined surfaces 131, which is greater than a rib inclination angle Θ of the other inclined surface 131. That is, the shape of the third rib 130 located on the uppermost side and the shape of the third rib 130 located on the lowermost side are configured differently. With this configuration, it is possible to effectively prevent maximum deformation from occurring in a portion adjacent to the fastening part 300 when the fastening force of the fastening member 30 is applied.

Therefore, by forming the rib inclination angle Θ formed on one inclined surface 131 disposed adjacent to the fastening part 300 among the pair of inclined surfaces 131 being greater than the rib inclination angle Θ formed on the other inclined surface 131, even if stress is concentrated in a portion adjacent to the fastening part 300, deformation of the locking part 200 can be effectively prevented.

As an example, the rib inclination angle Θ of one of the inclined surfaces 131 may be formed at 30°, and the rib inclination angle Θ formed on the other inclined surface 131 may be formed at 15°, but is not necessarily limited thereto, and it is also possible to configure it differently depending on the diameter of the pipe 10 to which the coupling assembly is fastened.

As shown in FIG. 4, the body part 100 may be provided with a fourth rib 140 connecting the side surface of the body part 100 and the fastening part 300. As described above, when the coupling assembly is fastened using the fastening member 40, the fastening force of the fastening member 40 is applied to the fastening part 300, and stress is concentrated in a portion adjacent to the fastening part 300, and if the fourth rib 140 connecting the side surface of the body part 100 and the fastening part 300 is provided, deformation of the locking part 200 can be more effectively prevented.

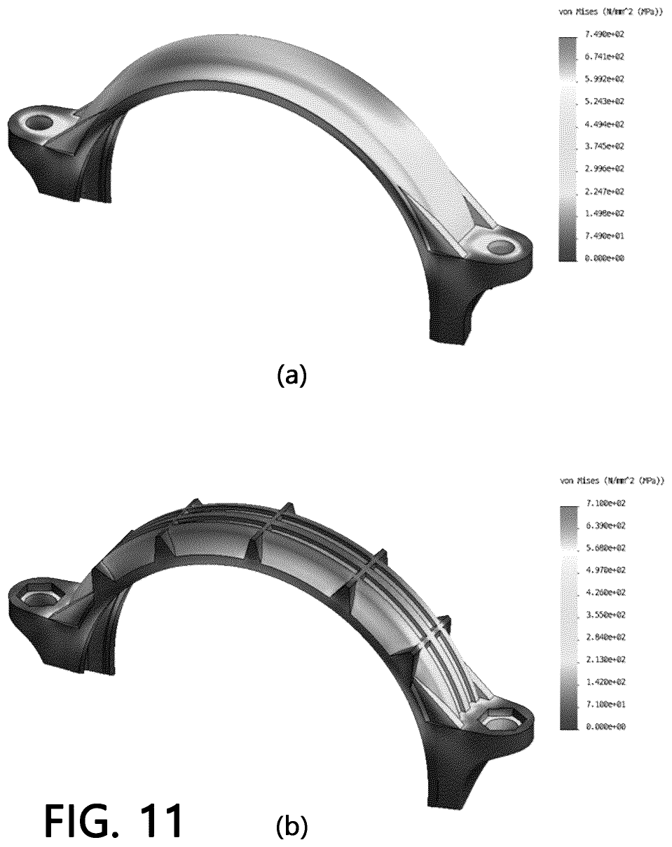

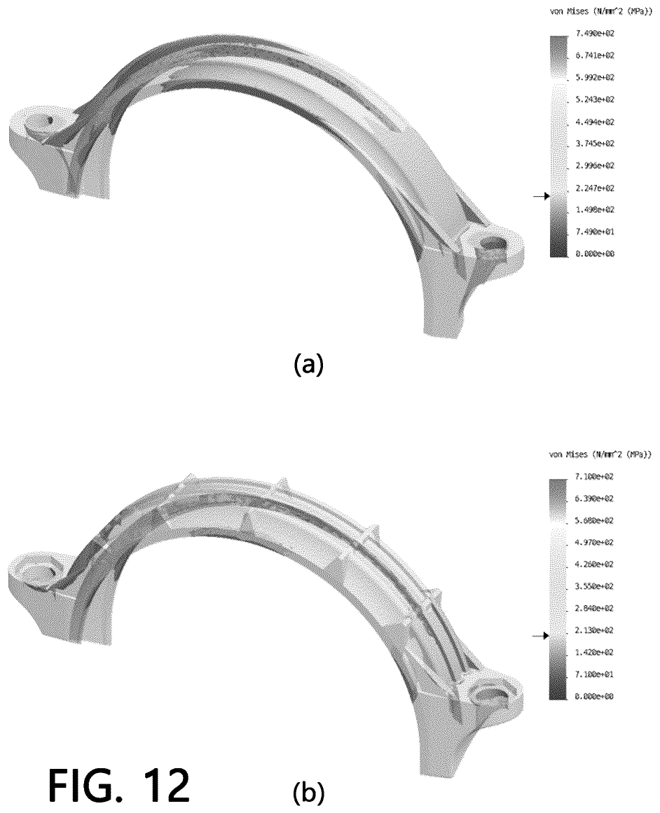

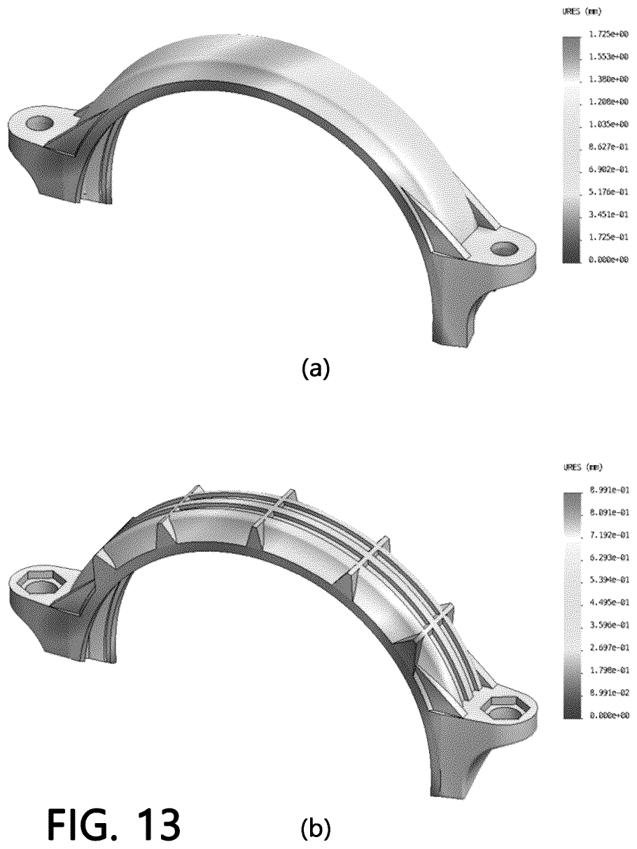

FIG. 11 is a simulation result of the overall stress distribution formed in the coupler when the coupling assembly is fastened, where (a) is the result for the conventional coupler, and (b) is the result for the coupler according to the present invention; FIG. 12 is a simulation result of a stress distribution greater than or equal to the yield strength formed in the coupler when the coupling assembly is fastened, where (a) is the result for the conventional coupler, and (b) is the result for the coupler according to the present invention; and FIG. 13 is a simulation result of the total displacement according to the deformation of the coupler when the coupling assembly is fastened, where (a) is the result for the conventional coupler, and (b) is the result for the coupler according to the present invention.

As shown in FIG. 11, the maximum stress formed in the coupler 20 when the coupling assembly is fastened is not significantly different between the conventional coupler and the coupler 20 according to the present invention. However, in the conventional coupler, a high level of stress is distributed throughout the coupler 20, so deformation of the locking part 200 may easily occur, but it can be seen that in the coupler 20 according to the present invention, a high level of stress is formed only in some areas adjacent to the fastening part 300, thereby effectively preventing deformation of the locking part 200.

As shown in FIG. 12, comparing the stress greater than or equal to the yield strength formed in the coupler 20 when the coupling assembly is fastened, while the conventional coupler is vulnerable to deformation of the locking part 200 since stress greater than or equal to the yield strength is distributed not only in the fastening part 300 but also in the entire coupler 20, it can be seen that in the coupler 20 according to the present invention, deformation of the locking part 200 is more effectively prevented as stress greater than or equal to the yield strength is distributed only in a portion adjacent to the fastening part 300.

As shown in FIG. 13, comparing the total displacement according to the deformation of the coupler 20 when the coupling assembly is fastened, while the conventional coupler has a deformation of about 1.7 mm, it can be seen that since the coupler 20 according to the present invention has only a deformation of about 0.9 mm, deformation of the locking part 200 is more effectively prevented.

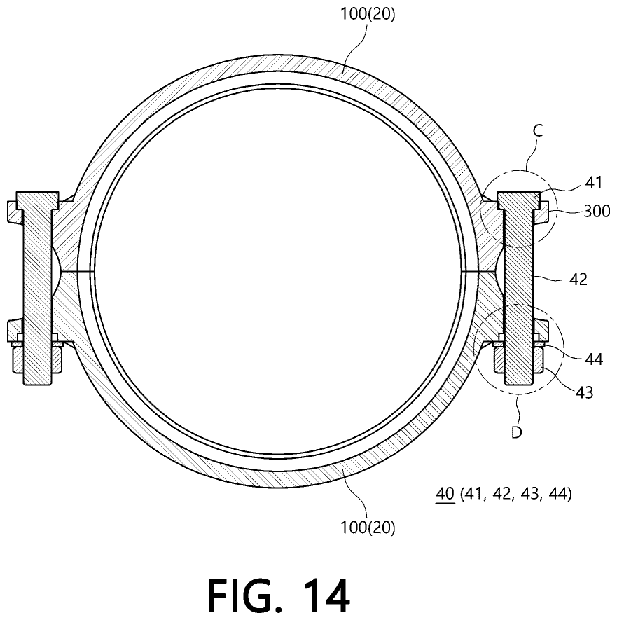

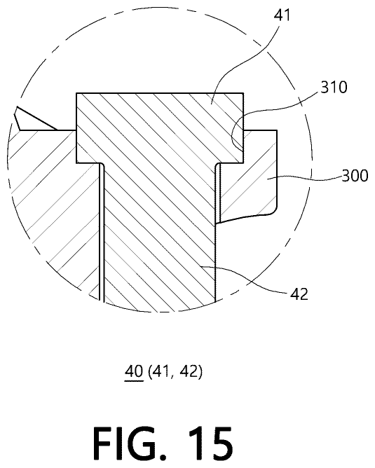

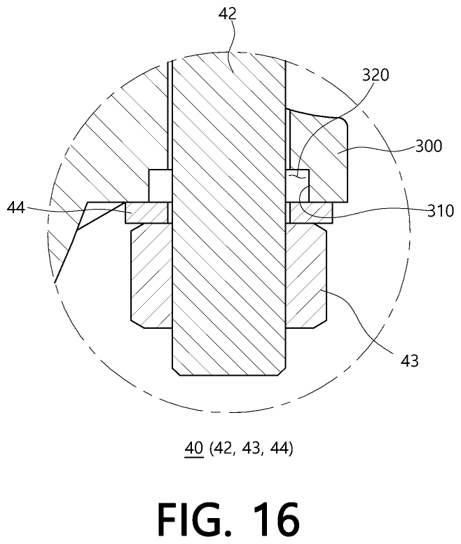

FIG. 14 is a cross-sectional view in the radial direction of a stainless steel coupling assembly for connecting pipes according to an embodiment of the present invention; FIG. 15 is an enlarged view of portion C of FIG. 14; and FIG. 16 is an enlarged view of portion D of FIG. 14.

As shown in FIGS. 14 and 15, the fastening member 40 includes a head 41 having a polygonal cross-section and a body 42 extending from the head 41, and the fastening part 300 may be provided with a support surface 310 that prevents the head 41 from rotating. As an example, this fastening member 40 may be a high-strength hexagonal bolt that can reinforce fastening force when the coupling assembly is fastened, but is not necessarily limited thereto and can be changed in various ways depending on design specifications.

That is, with the pair of couplers 20 arranged opposite to each other, the head 41 is arranged to be supported on the support surface 310 provided at the fastening part 300 of one coupler 20, and the coupling assembly is fastened by coupling the nut 43, which will be described later, with the body 42 penetrating the fastening part 300 of the other coupler 20.

As shown in FIGS. 3 and 15, the fastening part 300 is provided with an insertion groove 320 into which the head 41 is inserted, and the support surface 310 may be disposed on the inner surface of the insertion groove 320. As this insertion groove 320 has a polygonal cross-section to correspond to the cross-sectional shape of the head 41, and the support surface 310 is provided on the inner surface of the insertion groove 320, the head 41 can be easily fixed by inserting the head 41 into the insertion groove 320.

That is, with the pair of couplers 20 arranged opposite to each other, the head 41 is arranged to be inserted into the insertion groove 320 provided at the fastening part 300 of one coupler 20, and the coupling assembly is fastened by coupling the nut 43, with the body 42 penetrating the fastening part 300 of the other coupler 20.

In this case, as shown in FIG. 8, it is also possible to support the head 41 so that it does not rotate by forming a support rib 330 provided with a support surface 310 without forming the insertion groove 320 in the fastening part 300. The support rib 330 may be disposed on both sides in the radial direction (r) with respect to FIG. 8, but is not necessarily limited thereto, and may be arranged together on both sides in the width direction (w), or may be arranged in plural numbers along the circumference to correspond to the cross-sectional shape of the head 41.

As shown in FIG. 16, the fastening member 40 may further include a nut 43 fastened to the body 42 with the body 42 disposed through the fastening part 300, and a support plate 44 having an outer diameter greater than the outer diameter of the insertion groove 320 to prevent the nut 43 from being inserted into the insertion groove 320.

As described above, with a pair of couplers 20 arranged opposite each other, the coupling assembly is fastened using the fastening member 40, and when the nut 43 is fastened to the body 42, it is important that the nut 43 is rotatable without being inserted into the insertion groove 320 of the fastening part 300, and since the outer diameter of the support plate 44 is greater than the outer diameter of the insertion groove 320 (diameter of the circumscribed circle of the insertion groove 320), smooth fastening is possible while the nut 43 rotates without being inserted into the insertion groove 320.

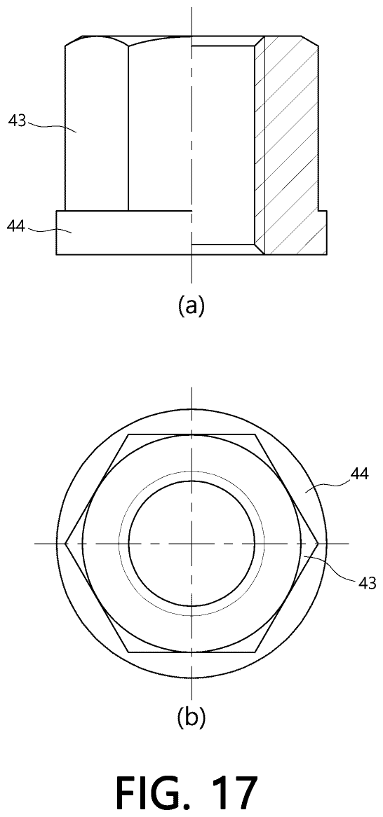

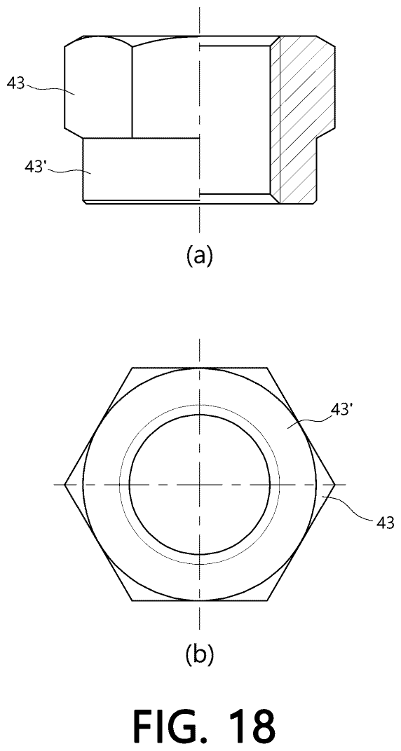

FIG. 17 is a view showing a nut according to another embodiment of the present invention, where (a) is a front view and (b) is a plan view; and FIG. 18 is a view showing a nut according to yet another embodiment of the present invention, where (a) is a front view and (b) is a plan view.

As shown in FIG. 17, the nut 43 and the support plate 44 may be formed integrally. When configured in this way, the total number of components in the coupling assembly is reduced, making management easier, and workability is improved as the operator can fasten the coupling assembly using only the nut 43.

In this case, as shown in FIG. 18, it is also possible to configure so that a rotating rib 43′ is formed on the bottom surface of the nut 43. It is preferable that the rotating rib 43′ is formed to have an outer diameter that is equal to or smaller than the inner diameter of the insertion groove 320 (diameter of the inscribed circle of the insertion groove 320), but the height of the rotating rib 43′ is equal to or greater than the height of the insertion groove 320.

With this configuration, even if the rotating rib 43′ is inserted into the insertion groove 320, it can rotate within the insertion groove 320, making it possible to fasten the coupling assembly through smooth rotation of the nut 43.

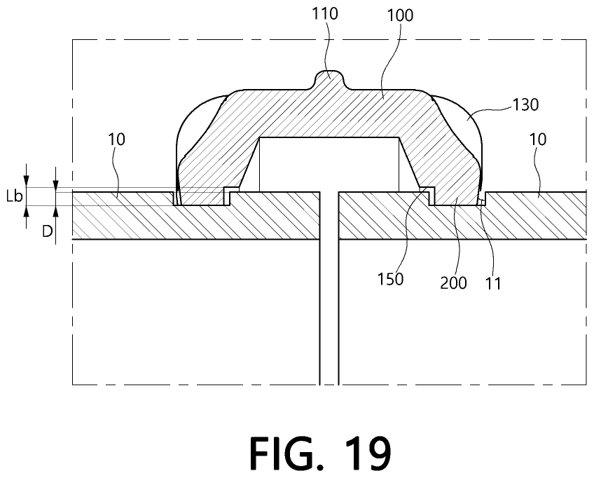

FIG. 19 is a cross-sectional view in the width direction of a stainless steel coupling assembly for connecting pipes and a pipe according to an embodiment of the present invention.

As shown in FIG. 19, the protruding length (Lb) in the radial direction (r) of the locking part 200 may be formed to be greater than the depth of the fastening groove 11. With this configuration, the bottom surface of the body part 100 of the coupler 20 can be disposed to be spaced apart from the outer surface of the pipe 10 even after the coupling assembly is fastened. If the bottom surface of the body part 100 is fastened in contact with the outer surface of the pipe 10, the pressure of the high-pressure fluid is applied to the pipe 10, causing deformation of the pipe 10, and this contact portion acts as a lever, and as a result, the locking part 200 may easily be separated from the fastening groove 11, but if bottom surface of the body part 100 of the coupler 20 is disposed to be spaced apart from the outer surface of the pipe 10, even if deformation of the pipe 10 occurs as the pressure of the high-pressure fluid is applied to the pipe 10, this deformation is not directly transmitted to the body part 100, thereby effectively preventing the locking part 200 from being separated from the fastening groove 11.

As shown in FIG. 19, the bottom surface of the body part 100 may be provided with a separation surface 150 spaced apart from the outer surface of the pipe 10. That is, as the separation surface 150 is provided on the bottom surface of the body part 100, even if deformation of the pipe 10 occurs as the pressure of the high-pressure fluid is applied to the pipe 10, this deformation is not directly transmitted to the body part 100, thereby effectively preventing the locking part 200 from being separated from the fastening groove 11.

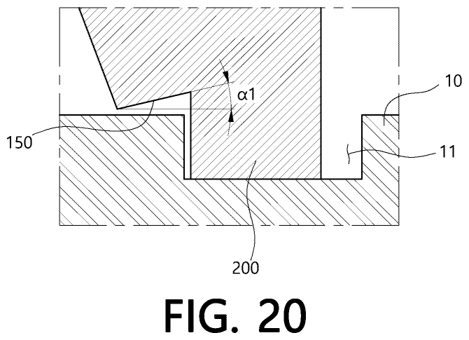

FIG. 20 is a cross-sectional view in the width direction of a stainless steel coupling assembly for connecting pipes and a pipe according to another embodiment of the present invention.

As shown in FIG. 20, a first body inclination angle α1 may be formed on the separation surface 150 so that the separation distance between the separation surface 150 and the outer surface of the pipe 10 increases along the width direction (w). With this configuration, even if deformation of the pipe 10 occurs as the pressure of the high-pressure fluid is applied to the pipe 10, the outer surface of the pipe 10 and the separation surface 150 gradually come into contact with each other, thereby effectively preventing the locking part 200 from being separated from the fastening groove 11.

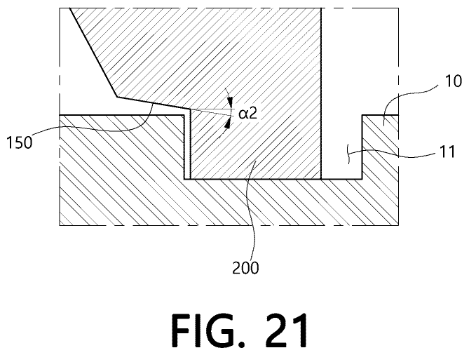

FIG. 21 is a cross-sectional view in the width direction of a stainless steel coupling assembly for connecting pipes and a pipe according to yet another embodiment of the present invention.

As shown in FIG. 21, a second body inclination angle α2 may be formed on the separation surface 150 so that the separation distance between the separation surface 150 and the outer surface of the pipe 10 decreases along the width direction (w). With this configuration, even if deformation of the pipe 10 occurs as the pressure of the high-pressure fluid is applied to the pipe 10, the outer surface of the pipe 10 and the separation surface 150 gradually come into contact with each other, thereby effectively preventing the locking part 200 from being separated from the fastening groove 11.

As seen above, in the stainless steel coupling assembly for connecting pipes according to an embodiment of the present invention, since the first rib 110 protruding outward in the radial direction (r) is formed on the top surface of the body part 100 and extends along the circumferential direction (a), even if high-pressure fluid, such as gas or water, flows inside the pipe 10 while the coupling assembly is fastened to the pipe 10, the first rib 110 prevents deformation of the coupler 20, so that the locking part 200 does not separate from the fastening groove 11, and through this, it is possible to effectively prevent water leakage from occurring in the pipe 10.

Although embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.
[Assignment unique number] 003170012
[Assignment number] 2022003170012 [Ministry name] Korea Ministry of Environment
[Assignment management (professional) organization name] Korea Environment Industry & Technology Institute
[Research Project Name] Prospective green technology innovation project
[Research assignment name] Commercialization of green innovation technology innovation grooved joint that meets KS and ANSI standards for smart water management
[Contribution rate] 1/1
[Name of project carrying out organization] New Asia Co., Ltd.
[Research period] 2022.04.01˜2024.12.31

This work was supported by Korea Environment Industry & Technology Institute (KEITI) through Prospective green technology innovation project, funded by Korea Ministry of Environment (MOE). (2022003170012)

What is claimed is:

1. A stainless steel coupling assembly for connecting pipes, in which two or more stainless steel couplers are placed opposite to connect the pipes continuously placed along the axial direction, and the pipes are connected in such a way that the plurality of couplers are disposed around the pipes and are fastened to each other,
wherein the coupler comprises:
a body part provided with an internal space where a sealing member is disposed;
a locking part that extends inward in the radial direction at both ends of the body part in the width direction and is inserted into a fastening groove formed in the pipe; and
a fastening part disposed at both ends in the circumferential direction of the body part and through which a fastening member is fastened,
wherein on the top surface of the body part, a first rib protruding outward in the radial direction is formed extending along the circumferential direction.

2. The stainless steel coupling assembly for connecting pipes of claim 1, wherein at least one first rib is provided along the width direction.

3. The stainless steel coupling assembly for connecting pipes of claim 1, wherein on the top surface of the body part, a second rib protruding outward in the radial direction is formed extending along the width direction.

4. The stainless steel coupling assembly for connecting pipes of claim 3, wherein at least one second rib is provided along the circumferential direction.

5. The stainless steel coupling assembly for connecting pipes of claim 1, wherein on a side surface of the body part, a third rib protruding along the width direction is formed extending along the radial direction.

6. The stainless steel coupling assembly for connecting pipes of claim 5, wherein at least one third rib is provided along the circumferential direction.

7. The stainless steel coupling assembly for connecting pipes of claim 5, wherein the extension length of the third rib in the circumferential direction increases as it goes inward in the radial direction.

8. The stainless steel coupling assembly for connecting pipes of claim 7, wherein the third rib is provided with an inclined surface arranged to form a constant rib inclination angle based on a center line disposed along the radial direction.

9. The stainless steel coupling assembly for connecting pipes of claim 8,
wherein the third rib is provided with a pair of inclined surfaces arranged opposite to each other along the circumferential direction, and
the rib inclination angle of the pair of inclined surfaces is formed to be equal to each other.

10. The stainless steel coupling assembly for connecting pipes of claim 8,
wherein the third rib is provided with a pair of inclined surfaces arranged opposite to each other along the circumferential direction, and
the rib inclination angles of the pair of inclined surfaces are formed to be different from each other.

11. The stainless steel coupling assembly for connecting pipes of claim 10, wherein among the pair of inclined surfaces, the rib inclination angle of one inclined surface disposed adjacent to the fastening part is formed to be greater than the rib inclination angle of the other inclined surface.

12. The stainless steel coupling assembly for connecting pipes of claim 1, wherein the body part is provided with a fourth rib connecting a side surface of the body part and the fastening part.

13. The stainless steel coupling assembly for connecting pipes of claim 1,
wherein the fastening member comprises a head having a polygonal cross-section, and a body extending from the head, and
the fastening part is provided with a support surface that prevents the head from rotating.

14. The stainless steel coupling assembly for connecting pipes of claim 13,
wherein the fastening part is provided with an insertion groove into which the head is inserted, and
the support surface is disposed on the inner surface of the insertion groove.

15. The stainless steel coupling assembly for connecting pipes of claim 14, wherein the fastening member further comprises a nut fastened to the body with the body disposed through the fastening part, and a support plate having an outer diameter greater than the outer diameter of the insertion groove to prevent the nut from being inserted into the insertion groove.

16. The stainless steel coupling assembly for connecting pipes of claim 15, wherein the nut and the support plate are formed integrally.

17. The stainless steel coupling assembly for connecting pipes of claim 1, wherein the protruding length in the radial direction of the locking part is formed to be greater than the depth of the fastening groove.

18. The stainless steel coupling assembly for connecting pipes of claim 17, wherein the bottom surface of the body part is provided with a separation surface spaced apart from the outer surface of the pipe.

19. The stainless steel coupling assembly for connecting pipes of claim 18, wherein a first body inclination angle is formed on the separation surface so that a separation distance between the separation surface and the outer surface of the pipe increases along the width direction.

20. The stainless steel coupling assembly for connecting pipes of claim 18, wherein a second body inclination angle is formed on the separation surface so that a separation distance between the separation surface and the outer surface of the pipe decreases along the width direction.
